(19) United States
(12) Patent Application Publication
(10) Pub. No.: US 2010/0029587 A1
(43) Pub. Date: Feb. 4, 2010

(54) CYCLIC SILOXANES AND THEIR USE

(76) Inventors: Arndt Brückner, Mulheim a.d. Ruhr (DE); Martin Glos, Borken (DE); Frauke Henning, Essen (DE); Ewald Sieverding, St. Johann (DE)

Correspondence Address: FROMMER LAWRENCE & HAUG, 745 FIFTH AVENUE- 10TH FL., NEW YORK, NY, 10151, US

(21) Appl. No.: 12/520,288

(22) PCT Filed: Nov. 5, 2007
(86) PCT No.: PCT/EP2007/061874

§ 371 Date: Jun. 19, 2009

(30) Foreign Application Priority Data
Dec. 20, 2006 (DE) 10 2006 060 115.7

(51) Int. Cl. A01N 55/10; C07F 7/08; C08J 9/00; A01P 1/00

(52) U.S. Cl. 514/63; 556/460; 521/86

(57) ABSTRACT

The invention relates to cyclic siloxanes in which organically modifying groups are bonded to the silicon atom via an oxygen atom (SiOC linkage), and to their use in the production of polyesterpolyurethane and as additive for enhancing the activity of biocides and pesticides.

Organically modified siloxanes are employed in a large number of industrial applications as the result of their unique properties such as hydrophobicity, surface activity, temperature stability and the like. These applications include the stabilization of polyurethane foams, the use as emulsifiers, in release coatings and many more.

As a rule, these siloxanes have a linear or branched structure, terminally modified or comb-type modified structure. Thus, for example, EP 0 048 984 and the patent specifications cited therein describe various linear siloxanes with different pendant groups (cyano groups, polyoxyalkylene groups and phenyl groups) for use in polyesterpolyurethane foam.

U.S. Pat. No. 5,908,871 describes a polyethersiloxane based on heptamethyltrisiloxane for use as stabilizer in PU ester foam. Here, foaming involves the use of the siloxanes in amounts of from 1 to 1.5 parts per 100 parts of the polyol.

The German Offenlegungschrift D 14 93 380 describes polyether-modified cyclic siloxanes of the general formula (I)

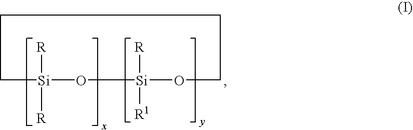

in which
R is a methyl or ethyl group,
R¹ is a residue CₘH₂ₘ(OC₂H₄)ₙ(OC₃H₆)ₚOR² and
R² is a methyl, ethyl, propyl or butyl radical,
their preparation and use as wetters, in particular for aqueous paints, adhesives, printing inks, dips and emulsions.

The German patent specification DE 196 31 227 claims the use of such cyclic siloxanes with polyether residues as foam stabilizers, in particular for polyurethane foam. It emphasizes the financial advantage of cyclic siloxanes over linear siloxanes inasfar as the production of cyclic siloxane raw materials does not require any trimethylchlorosilane, which is only generated in amounts of 2 to 4% in the silane synthesis by the method of Rochow.

In both specifications, the residue R¹ is bonded directly to a silicon atom via a carbon atom (SiC linkage). The SiC linkage is the result of a hydrosilylation of mostly allyl-alcohol-initiated polyethers. In comparison with, for example, butanol-initiated polyethers, however, allyl-alcohol-initiated polyethers involve higher production costs. Moreover, the use of allyl alcohol is toxicologically problematic. A further disadvantage is that the described hydrosilylation reactions require a greater excess of polyether for achieving complete conversion. This is due to the rearrangement of the allyl ether to give the corresponding propenyl polyether. This not only reduces the active content of the products, but may, owing to hydrolysis of the propenyl polyether, also lead to the release of propionaldehyde, which leads to an intrinsic odor which is undesired in the application. Finally, the hydrosilylation procedure requires an expensive noble-metal catalyst, in most cases based on platinum.

There was therefore a demand for cyclic polyether-siloxanes which can be prepared in a technically simple and economic manner and with a pronounced interface activity.

Surprisingly, it has been found that the object of the invention can be achieved by cyclic siloxanes whose organically modified group is bonded to the silicon atom via an oxygen atom (SiOC linkage).

The invention therefore relates to cyclic siloxanes of the general formula (II)

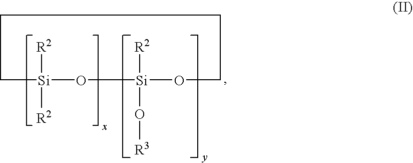

in which
R² are identical or different, straight-chain or branched, aliphatic or aromatic, optionally halogenated, optionally unsaturated hydrocarbon radicals having 1 to 8 carbon atoms, preferably one carbon atom,
x is 3, 4 or 5,
y is 1, 2 or 3,
R³ represents a group of the formula A-B-C-D, where A is a group

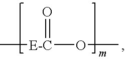

where
m is an integer from 0 to 30 and
E may be in each case independently a divalent group selected from among linear or branched, saturated, mono- or polyunsaturated alkyl, aryl, alkylaryl or arylalkyl groups having 1 to 20 carbon atoms, preferably having 3 to 5 carbon atoms,
B is a group of the general formula (III)

—(C₂H₄O)ₙ(C₃H₆O)ₒ(C₁₂H₂₄O)ₚ(C₈H₈O)_{q}(C₄H₈O)ᵣ (III)
where
n, o, p, q and r independently of one another are integers from 0 to 50 and, if more than one of the indices n, o, p, q, r>0, the general formula III represents a random oligomer or a block oligomer,
C is selected from the group consisting of

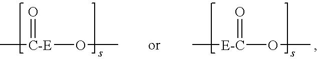

where
E in each case independently of one another can have the abovementioned meanings and
s is an integer from 0 to 20, but only other than 0 when the total of the indices n+o+p+q+r is 1 or greater,
and
D can be a radical selected from among hydrogen, linear or branched, saturated, mono- or polyunsaturated alkyl, aryl, alkylaryl or arylalkyl groups having 1 to 20 carbon atoms, optionally comprising one or more heteroatoms, optionally comprising one or more carbonyl groups, optionally modified with an ionic organic group which may comprise for example the heteroatoms of sulfur, phosphorus and/or nitrogen,
   where the total of the indices m+n+o+p+q+r+s must be 3 or greater. Preferably, the total of the indices m+n+o+s is 3 or greater. Especially preferably, the total of the indices n+o is 3 or greater.

D is preferably selected from the group consisting of

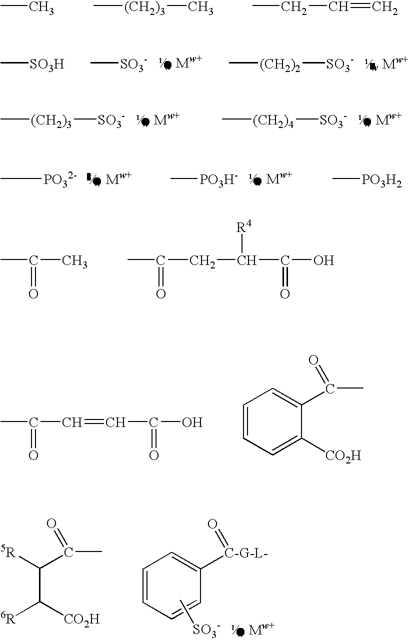

where
M^{w+} represents a w-valent cation with w=1, 2, 3 or 4, in particular K⁺, Na⁺, NH₄⁺, (i-C₃H₇)NH₃⁺ or (CH₃)₄N⁺, and
R⁴ represents hydrogen or an optionally branched aliphatic radical having 1 to 20 carbon atoms,
R⁵ and R⁶ represent identical or different, optionally bridged, optionally branched, aliphatic radicals,
G is an oxygen atom, NH or an NR⁷ group, where
R⁷ is a monovalent alkyl group,
L represents a divalent, optionally branched, alkyl radical.
D is particularly preferably selected from the group consisting of

—CH₃

—(CH₂)₃—CH₃

—CH₂—CH═CH₂

—SO₃⁻1/wM^{w+}

—(CH₂)₂—SO₃⁻1/wM^{w+}

—(CH₂)₃—SO₃⁻1/wM^{w+}

with the abovementioned meanings, and very especially preferably selected among the group consisting of allyl, n-butyl, ethyl and methyl.

In a preferred embodiment of the present invention, the radical R² of the general formula II represents methyl groups, y has the value 1, m=s=0, and D represents the abovementioned meanings.

In an especially preferred embodiment of the present invention, the radical R² of the general formula II represents methyl groups, y has the value 1, m=p=q=r=s=0, and the radical D represents allyl, n-butyl, ethyl or methyl.

The skilled worker knows that the compounds are present in the form of a mixture which is essentially governed by the laws of statistics. For example, a mixture of cyclotetra-, cyclopenta- and cyclohexasiloxanes may be present during preparation and use. It has proved particularly advantageous for the purposes of the invention when the siloxanes of the general formula II are employed as a mixture. Thus, a complicated fractional distillation can be dispensed with.

The unit —O—SiR²(OR³)— is present once to three times in the siloxane cycle. However, a mixture of molecules is present, so that a certain proportion of the molecules contains no, or several, units —O—SiR²(OR³)—, when, for example, y has an average value of 1.

The preparation of the cyclic siloxanes according to the invention can be accomplished following the methods known for linear or branched, terminally-modified or comb-type-modified siloxanes. Thus, several methods are available for the formation of an SiOC linkage. Traditionally, SiOC linkages are formed by a siloxane reacting with a leaving group bound to the silicon atom (for example halogen) and with an alcohol. Especially chlorosiloxanes are widespread for this type of reaction. Thus, the organically modified siloxanes according to the invention may be prepared for example by substitution of the chlorine atom in chloroheptamethylcyclotetrasiloxane or in chlorononamethylcyclopentasiloxane by an alcohol, for example an alkyl-initiated polyether.

As an alternative, the cyclic siloxanes according to the invention may be prepared by reacting an alcohol with siloxanes in which hydrogen is bonded to the silicon atom (hydrogen siloxanes). Suitable conditions lead to the formation of the SiOC bond and to the elimination of hydrogen. This dehydrogenating condensation reaction only proceeds in the presence of a catalyst. A process which is suitable for this purpose is, for example, the process described in European patent specification EP 1 460 098, in which organically modified polyorganosiloxanes are prepared by reaction hydrogen siloxanes with alcohols with a catalytic amount of a mixture of an organic acid and of its salt. As an alternative, the boron-containing catalysts described in DE 103 12 636 and DE 103 59 764 may be employed for the dehydrogenating condensation of hydrogen siloxanes and alcohols. Moreover, it is also possible to use the process described in the as yet unpublished patent application DE 10 2005 051 939.3 in which the dehydrogenating condensation is catalyzed by quaternary ammonium hydroxides. U.S. Pat. No. 5,147,965 mentions a process which is described in the Japanese patent publication 48-19941 and in which a hydrogen siloxane is reacted with an alcohol with addition of alkali metal hydroxides or alkali metal alkoxides. The contents of the abovementioned patent literature for forming the SiOC bond is herewith mentioned by way of reference and forms part of the disclosure of the present application.

Preference is given to the process of the dehydrogenating condensation of hydrogen siloxanes and alcohols catalyzed by boron-containing compounds, as described in DE 103 12 636 and DE 103 59 764 or, if appropriate, with addition of a cocatalyst, as specified in the application document EP 1 627 892. Alcohols which are preferably employed are OH-terminated polyethers.

Preference is given to the use of a mixture of cyclic siloxanes of the general formula (IV)

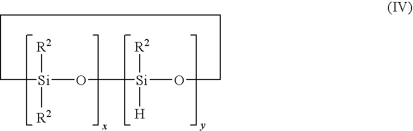

with the molecules:
a) where x=3 and y=1
b) where x=4 and y=1
c) where x=5 and y=1 and, if appropriate,
d) where x=4 and y=0 (octamethylcyclotetrasiloxane)
e) where x=5 and y=0 (decamethylcyclopentasiloxane) and
f) where x=6 and y=0 (undecamethylcyclohexasiloxane).

Very particular preference is given to the use of a mixture in which the proportion of compounds of the general formula (IV) where y=1 and x=3, 4 and 5 amounts to a total of 10 to 80% by weight and the remainder are siloxanes without silane hydrogen.

The proportions of volatile starting material without silane hydrogen, such as, for example, octamethylcyclotetrasiloxane, decamethylcyclopentasiloxane or undecamethylcyclohexasiloxane, after the dehydrogenating condensation reaction, can preferably be removed by distillation, if appropriate under reduced pressure.

The preparation can be accomplished with or without solvent, continuously or batchwise. The reactants can be mixed with one another in any order.

The present invention also relates to the use of the compounds of the general formula II, or to the use of technical mixtures comprising these compounds, in the preparation of polyesterpolyurethane foams.

The siloxanes according to the invention can be employed in smaller amounts than the previously known systems in polyesterpolyurethane foam without defective foams resulting.

Polyesterpolyurethane foams are prepared by reacting a reaction mixture consisting of
a) a polyesterpolyol which has on average at least two hydroxyl groups per molecule,
b) a polyisocyanate which has on average at least two isocyanate groups per molecule, where the polyol and the polyisocyanate account for most of the reaction mixture and the ratio of the two components to one another is suitable for producing a foam,
c) small amounts of a blowing agent which is sufficient for foaming the reaction mixture,
d) a catalytic amount of a catalyst for producing the polyurethane foam; in most cases, this consists of one or more amines; and
e) a small amount of a foam stabilizer which consists of siloxanes and/or other surfactants and which provides sufficient stabilization of the foaming mixture. Thus, the siloxanes according to the invention may also be employed as stabilizer, either alone or in combination with non-Si-containing surfactants. The siloxanes according to the invention may also be diluted in suitable solvents to simplify metering or else to improve the incorporation into the reaction mixture.

Further additives may be: flame retardants, cell openers, colorants, UV stabilizers, substances for preventing microbial attack and further additives which are known to the skilled worker and not mentioned here in greater detail.

It is possible to employ the polyesterpolyols, isocyanates, blowing agents, flame retardants, catalysts, additives and preparation processes which are known in the art. For example, the components detailed in the patent specification EP 0 048 984, which is herewith mentioned by way of reference, may be employed.

The present invention furthermore relates to the use of the compounds of the general formula II, or to the use of technical mixtures comprising these compounds, as additive for enhancing the effect of biocides and fertilizers, such as micronutrient fertilizers, and as spreading or nonspreading wetter in agrotechnical applications. Biocides means in particular, but not exclusively, pesticides and active ingredients which can be employed in agriculture for preventing damage during sowing, during the cultivation, the production and the storage of crop and noncrop plants and their harvested products and processed products and those which are employed in industry and in the household sector as a protection against plants including algae and mosses, animals, insects, fungi, bacteria, viruses and such pathogens. Such active ingredients include synthetic and biological materials. Such active ingredients may also be presented in chemical compositions, either alone or in conjunction with other active ingredients, and in various use forms and application forms, without or with other wetters. According to the prior art, organically modified siloxanes with linear structure, which are in most cases organically modified by pendant groups, are employed as silicone wetters for agricultural applications. The contents of the specifications EP 1 314 356, U.S. Pat. No. 5,017,216, WO 89/12394, WO 99/40785, U.S. Pat. No. 6,051,533, U.S. Pat. No. 6,040,272 and EP 0 483 095 are herewith mentioned by way of reference and form part of the disclosure of the present application. The preparation of these siloxanes requires expensive trimethylchlorosilane as terminal groups of the silicone chain. As has already been mentioned above, the silane synthesis by the method of Rochow only generates 2 to 4% of trimethylchlorosilane. Surprisingly, it has been found that cyclic siloxanes of the general formula II, whose preparation does not require any trimethylchlorosilane, enhance the activity of biocides. It has been found entirely unexpectedly that cyclic siloxanes according to the invention are, indeed, more active than prior-art noncyclic linear trisiloxane surfactants. As a consequence, it can be assumed that the compounds of the general formula II according to the invention enhance the activity of all biocides and other synthetic and biologically active constituents, such as, for example, all those which are listed in “The Pesticide Manual”, 14th edition, British Crop Protection Council and in “The Manual of Biocontrol Agents” by L.G. Copping, British Crop Protection Council. The compounds of the general formula II according to the invention not only improve the plant's provision with plant protectants, but they also improve the uptake and efficacy of nutrients and micronutrients. The compounds of the general formula II according to the invention can additionally be employed as wetters for foliar and soil treatments.

Moreover, the compounds of the general formula II according to the invention, or the use of technical mixtures comprising these compounds, may also be employed as wetters, antifoams and emulsifiers and for stabilizing aqueous foams. In particular, the compounds of the general formula II according to the invention, or the use of technical mixtures comprising these compounds, are suitable as additives for paints and coatings, adhesives and cosmetic products. The compounds of the general formula II according to the invention, or the use of technical mixtures comprising these compounds, are very particularly suitable as additives for automotive coatings, industrial coatings and printing inks.

### USE EXAMPLES

### General Aspects

### Siloxanes

In those use examples which mention a cyclics mixture, these take the form of mixtures consisting of heptamethylcyclotetrasiloxane, nonamethylcyclopentasiloxane, undecamethylcyclohexasiloxane, octamethylcyclotetrasiloxane and decamethylcyclopentasiloxane, where the reactive siloxanes are present in the following molar ratio:

| | |
|---|---|
| heptamethylcyclotetrasiloxane | 47% |
| nonamethylcyclopentasiloxane | 41% |
| undecamethylcyclohexasiloxane | 12%. |

### Alcohols

The polyether alcohols are freed from all volatile constituents by distillation in vacuo before being used.

### Conduct of the Reaction

All reactions are carried out under protective gas. The reaction gives rise to hydrogen, which is removed via a bubble counter. The ratio of OH groups of the organically modifying groups to silane hydrogen can be chosen at will, preferably in the range of from 0.5 to 2, especially preferably in the range of from 1 to 1.5.

### Work-Up

Unless otherwise described, the following standard work-up procedure will be chosen: after the reaction has ended, the reaction mixture is freed from volatile substances at a temperature of 130° C. under reduced pressure, preferably 20 to 30 mbar.

### Analyses

The degree of conversion is determined by measuring the residual SiH functions by means of gas-volumetric determination of hydrogen [conversion in %]. The OH number is determined by reacting phthalic anhydride with free hydroxyl groups. The free acid is backtitrated with a base solution [OH number stated in mg KOH/g test substance]. The presence of the Si—O—C linkage in question is verified in each case by an ²⁹Si-NMR-spectroscopic examination of the reaction product.

Reactions of Cyclic Hydrogen Siloxanes with Alcohols in a Dehydrogenating Condensation:

### Syntheses

### Example 1

### Reaction of Heptamethylcyclotetrasiloxane with a Polyester Monool

25.2 g of the polycaprolactone Placcel FA 3 (v=3), which is available from Daicel and which has an OH number of 122.5 are reacted with 0.05 mol of heptamethylcyclotetrasiloxane. The polyester is introduced first, heated at 90° C. and treated with 50 mg of tris(perfluorotriphenyl)borane and the siloxane. The mixture is then heated at 110° C., during which process a gas is formed which is removed under controlled conditions. After the gas-volumetric determination of hydrogen reveals that the conversion is quantitative, the reaction product is worked up as described above.

### Example 2

### Reaction of a Cyclics Mixture with a Butyl-Alcohol-Initiated, Purely Propylene-Oxide (PO)-Unit-Containing Polyether

The cyclics mixture (corresponding to 0.24 mol SiH) is reacted with 0.31 mol of a butyl-alcohol-initiated, purely PO-containing polyether (average molar mass 1800 g/mol). The polyether is first introduced, heated at 100° C. and treated with 690 mg of tris(perfluorotriphenyl)borane. The siloxane is added dropwise at 100° C. in the course of 140 minutes. This gives rise to a gas which is removed under controlled conditions. The gas-volumetric determination of hydrogen reveals that the conversion is quantitative. The reaction product is worked up as described above.

### Example 3

### Reaction of a Cyclics Mixture with a Butyl-Alcohol-Initiated, Ethylene-Oxide (EO)- and Propylene-Oxide (PO)-Unit-Containing Polyether

The cyclics mixture (corresponding to 0.26 mol SiH) is reacted with 0.34 mol of a butyl-alcohol-initiated EO/PO-containing polyether (average molar mass 900 g/mol, approx. 70% EO, 30% PO). The polyether is introduced first, heated at 60° C. and treated with 230 mg of tris(perfluorotriphenyl)borane. The siloxane is added dropwise at 90° C. in the course of 2 hours.

During the dropwise addition, a further 230 mg of tris(perfluorotriphenyl)borane are added. This gives rise to a gas which is removed under controlled conditions. The gas-volumetric determination of hydrogen reveals that the conversion is 97%. The reaction product is worked up as described above.

### Example 4

### Reaction of a Cyclics Mixture with a Butyl-Alcohol-Initiated, Ethylene-Oxide (EO)- and Propylene-Oxide (PO)-Unit-Containing Polyether

The cyclics mixture (corresponding to 0.26 mol SiH) is reacted with 0.34 mol of a butyl-alcohol-initiated EO/PO-containing polyether (average molar mass 1000 g/mol, approx. 70% EO, 30% PO). The polyether is introduced first, heated at 60° C. and treated with 500 mg of tris(perfluorotriphenyl)borane. The siloxane is added dropwise at 90° C. in the course of 2 hours. This gives rise to a gas which is removed under controlled conditions. The gas-volumetric determination of hydrogen reveals that the conversion is quantitative. The reaction product is worked up as described above.

### Example 5

### Reaction of a Cyclics Mixture with a Butyl-Alcohol-Initiated, Ethylene-Oxide (EO)- and Propylene-Oxide (PO)-Unit-Containing Polyether

The cyclics mixture (corresponding to 0.40 mol SiH) is reacted with 0.52 mol of a butyl-alcohol-initiated EO/PO-containing polyether (average molar mass 500 g/mol, approx. 20% EO, 80% PO). The polyether is introduced first, heated at 100° C. and treated with 600 mg of tris(perfluorotriphenyl)borane. The siloxane is added dropwise at 100° C. in the course of 2.5 hours. This gives rise to a gas which is removed under controlled conditions. The gas-volumetric determination of hydrogen reveals that the conversion is quantitative. The reaction product is worked up as described above.

### Example 6

### Reaction of a Cyclics Mixture with a Butyl-Alcohol-Initiated, Ethylene-Oxide (EO)- and Propylene-Oxide (PO)-Unit-Containing Polyether

The cyclics mixture (corresponding to 0.40 mol SiH) is reacted with 0.52 mol of a butyl-alcohol-initiated EO/PO-containing polyether (average molar mass 1400 g/mol, approx. 40% EO, 60% PO). The polyether is introduced first, heated at 100° C. and treated with 710 mg of tris(perfluorotriphenyl)borane. The siloxane is added dropwise at 100° C. in the course of 2.5 hours. This gives rise to a gas which is removed under controlled conditions. The gas-volumetric determination of hydrogen reveals that the conversion is 98%. The reaction product is worked up as described above.

### Example 7

### Reaction of a Cyclics Mixture with a Butyl-Alcohol-Initiated, Purely Ethylene-Oxide (EO)-Unit-Containing Polyether

The cyclics mixture (corresponding to 0.33 mol SiH) is reacted with 0.36 mol of a butyl-alcohol-initiated, purely EO-containing polyether (average molar mass 500 g/mol). The polyether is first introduced, heated at 100° C. and treated with 430 mg of tris(perfluorotriphenyl)borane. The siloxane is added dropwise at 110° C. in the course of 3 hours. This gives rise to a gas which is removed under controlled conditions. The gas-volumetric determination of hydrogen reveals that the conversion is quantitative. The reaction product is worked up as described above.

### Example 8

### Reaction of a Cyclics Mixture with a Allyl-Alcohol-Initiated, Ethylene-Oxide (EO)- and Propylene-Oxide (PO)-Unit-Containing Polyether

The cyclics mixture (corresponding to 0.40 mol SiH) is reacted with 0.52 mol of a allyl-alcohol-initiated EO/PO-containing polyether (average molar mass 500 g/mol, approx. 60% EO, 40% PO). The polyether is introduced first, heated at 100° C. and treated with 500 mg of tris(perfluorotriphenyl)borane. The siloxane is added dropwise at 100° C. in the course of 2.5 hours. This gives rise to a gas which is removed under controlled conditions. The gas-volumetric determination of hydrogen reveals that the conversion is 97%. The reaction product is worked up as described above.

### Example 9

### Reaction of a Cyclics Mixture with a Allyl-Alcohol-Initiated, Purely Ethylene-Oxide (EO)-Unit-Containing Polyether

The cyclics mixture (corresponding to 0.33 mol SiH) is reacted with 0.36 mol of a allyl-alcohol-initiated, purely EO-containing polyether (average molar mass 500 g/mol). The polyether is first introduced, heated at 100° C. and treated with 430 mg of tris(perfluorotriphenyl)borane. The siloxane is added dropwise at 110° C. in the course of 3.5 hours. This gives rise to a gas which is removed under controlled conditions. The gas-volumetric determination of hydrogen reveals that the conversion is 99%. The reaction product is worked up as described above.

### Example 10

### Reaction of a Cyclics Mixture with a Butyl-Alcohol-Initiated, Ethylene-Oxide (EO)- and 1-dodecene-oxide (DO)-Unit-Containing Polyether

The cyclics mixture (corresponding to 0.20 mol SiH) is reacted with 0.26 mol of a butyl-alcohol-initiated, EO/DO-containing polyether (average molar mass 500 g/mol, approx. 90% EO, 10% DO). The polyether is introduced first, heated at 100° C. and treated with 400 mg of tris(perfluorotriphenyl)borane. The siloxane is added dropwise at 100° C. in the course of 2 hours. This gives rise to a gas which is removed under controlled conditions. The gas-volumetric determination of hydrogen reveals that the conversion is 95%. The reaction product is worked up as described above.

### Example 11

### Reaction of a Cyclics Mixture with a Butyl-Alcohol-Initiated, Ethylene-Oxide (EO)- and Styrene-Oxide (SO)-Unit-Containing Polyether

The cyclics mixture (corresponding to 0.20 mol SiH) is reacted with 0.26 mol of a butyl-alcohol-initiated, EO/SO-containing polyether (average molar mass 800 g/mol, approx. 90% EO, 10% SO). The polyether is introduced first, heated at 110° C. and treated with 400 mg of tris(perfluorotriphenyl)borane. The siloxane is added dropwise at 110° C. in the course of 3 hours. This gives rise to a gas which is removed under controlled conditions. The gas-volumetric determination of hydrogen reveals that the conversion is 99%. The reaction product is worked up as described above.

### Example 12

### Reaction of a Cyclics Mixture with a Butyl-Alcohol-Initiated, Ethylene-Oxide (EO)- and 1-Butene-Oxide (BO)-Unit-Containing Polyether

The cyclics mixture (corresponding to 0.20 mol SiH) is reacted with 0.26 mol of a butyl-alcohol-initiated, EO/BO-containing polyether (average molar mass 400 g/mol, approx. 90% EO, 10% BO). The polyether is introduced first, heated at 100° C. and treated with 400 mg of tris(perfluorotriphenyl)borane. The siloxane is added dropwise at 100° C. in the course of 2 hours. This gives rise to a gas which is removed under controlled conditions. The gas-volumetric determination of hydrogen reveals that the conversion is 98%. The reaction product is worked up as described above.

### Comparative Example 1

A heptamethyltrisiloxane is reacted by prior-art methods with allyl-alcohol-initiated polyether with a PO content of 30% and an EO content of 70% and an average molar mass of 900 g/mol, using a suitable Pt catalyst, to give the corresponding polyether siloxane.

### Comparative Example 2

The cyclics mixture is reacted by prior-art methods with an allyl-alcohol-initiated polyether with a PO content of 30% and an EO content of 70% and an average molar mass of 500 g/mol, using a suitable Pt catalyst, to give the corresponding polyether siloxane.

### Comparative Example 3

The cyclics mixture is reacted by prior-art methods with an allyl-alcohol-initiated, methyl-end-capped polyether with a PO content of 30% and an EO content of 70% and an average molar mass of 500 g/mol, using a suitable Pt catalyst, to give the corresponding polyether siloxane.

### Examples of the Preparation of Flexible Polyester-Polyurethane Foam

### Raw Materials

Desmophen 2200 from Bayer
Toluylenediisocyanate (TDI 80/20 and TDI 65/35) from Bayer, N-methylmorpholine (NMM).

### Formula

100 parts polyester polyol
34.5 parts TDI 80
23 parts TDI 65
5.1 parts water
1.4 parts NMM, 0.195 part (or more) siloxane.

Here, an activator solution is prepared from water, amine and siloxane with addition of 1.1 parts of a polyether with 90% PO and 10% EO and an average molar mass of 2000 g/mol as solubilizer.

Foaming is carried out on a high-pressure machine from Hennecke, model UBT, with an output of 4 kg/min. The polyol, the isocyanates and the activator solution are metered separately. The reaction mixture is metered into a paper-lined container having a base area of 30×30 cm. The height of rise and settling are determined. Settling means the decrease of the height of rise 1 minute after reaching the maximum height of rise.

After the foams have cured, the cell number and the air permeability are determined. The air permeability is a measure for the proportion of open cells in the foam. A foam with as high an open-cell content as possible is desired for a large number of applications. The open-cell content of the foams is determined here via the air permeability. Air permeability is stated in mm dynamic pressure (water column) which builds up when a constant stream of air is passed through the foam. The higher the stated value, the more closed-cell is the foam, and vice versa.

The results of the foaming of siloxanes according to the invention (Examples 13 to 17) and of noninventive siloxanes of the prior art (Comparative Examples 4 and 5) are compiled in the table which follows.

Shown are the siloxane, the amount used (in parts), the foam height (cm), the settling (cm), the air permeability (mm) and the cell number (cm⁻¹) of the resulting foams.

TABLE 1

| | | | Foam | | Air | Cell | |
|---|---|---|---|---|---|---|---|
| | Siloxane | Amount | height | Settling | permeability | number | |
| | of | (parts) | (cm) | (cm) | (mm) | (cm⁻¹) | Notes |
| Ex. 13 | Ex. 3 | 0.195 | 29.2 | 1.3 | 11 | 13 | no faults |
| Ex. 14 | Ex. 4 | 0.195 | 28.9 | 1.5 | 12 | 13 | no faults |
| Ex. 15 | Ex. 5 | 0.195 | 29.2 | 1.3 | 17 | 12 | no faults |
| Ex. 16 | Ex. 6 | 0.195 | 28.6 | 1.2 | 15 | 13 | no faults |
| Ex. 17 | Ex. 8 | 0.195 | 29 | 1.5 | 10 | 13 | no faults |
| Comp. 4 | Comp. 1 | 0.39 | 28.7 | 2.6 | 12 | 12 | fissures |
| Comp. 5 | Comp. 1 | 0.195 | — | — | — | — | collapse |

### Examples of the Enhancement of the Activity of Plant Protection Products

### Examples 18 and 19

In a greenhouse, barley cv. “Ingrid” (3 plants per pot) are sown in “Frutosol” potting compost. Three weeks later, the plants' leaves, which were approx. 10 to 15 cm in length, were inoculated with fresh conidia of the mildew fungus Blumeria graminis f. sp. hordei (Rasse A6) by means of an inoculation tower. Two days later, they are sprayed with a spray mixture comprising the fungicide Opus® (BASF, with 125 g active substance/epoxiconazole per liter). The spray rate corresponds to 250 l/ha. This is also carried out in other variants in which the spray mixture also comprises various wetters, in addition to Opus®. The dosage rates of the pesticide and of the wetters are detailed in the results table. After the spray film has dried, leaf segments 8 cm in length are excised from the treated and also from entirely untreated plants, and 13 leaves are placed on benzimidazole agar in Petri dishes separately for each variant (0.5% agar added to the 40 ppm benzimidazole after sterilization). The incidence of mildew disease is examined after incubation for 7, 14 and 21 days at room temperature by estimating the amount of infected leaf area. This experimental set-up is familiar to the expert worker.

The efficacy of the pesticide and of the combination of pesticide and wetter is assessed in the manner known to the expert worker in comparison with a control sample which is untreated, but inoculated with the mildew fungus.

TABLE 2

| | Treatment | Efficacy |
|---|---|---|
| Comp. 6 | Opus ® [10 ml/ha] | 59% |
| Ex. 18 | Opus ® [10 ml/ha] + 25 ml/ha Ex. 7 | 74% |
| Ex. 19 | Opus ® [10 ml/ha] + 25 ml/ha Ex. 9 | 78% |
| Comp. 7 | Opus ® [10 ml/ha] + 25 ml/ha Comp. 2 | 62% |
| Comp. 8 | Opus ® [10 ml/ha] + 25 ml/ha Comp. 3 | 45% |
| Comp. 9 | Opus ® [10 ml/ha] + 25 ml Break-Thru S 240 | 75% |

When the plants are sprayed, the fungal spores have already infected the leaf tissue. To control the disease, the fungicide must therefore penetrate the leaf in order to adversely affect the fungal growth. The comparison of Examples 18 and 19 according to the invention with Comparative Example 6 (treated control without wetter) shows that compounds of the general formula II according to the invention drastically increase the biological activity of crop protection products. Surprisingly, it has been found that the activity of the compound according to the invention of Example 9 is even higher than the activity of the trisiloxane wetter BREAK-THRU® S 240 (Degussa Goldschmidt GmbH), which is commercially available for such an application. This trisiloxane surfactant has a noncyclic linear structure and is laterally modified, that is to say modified on the middle one of the three silicon atoms.

### Examples 20 to 23

In a field trial with maize, 21 m² plots are distributed randomly in blocks which are replicated four times. The four plots of each treatment are sprayed with or without herbicide or with the wetter combinations given in Table 3 when the maize is in growth stage 17 (BBCH scale). At this point in time, the predominant accompanying vegetation are the grass Echinocloa cruz-galli (growth stage 25) and the weed Chenopodium album (growth stage 19). The products are diluted with water and applied at a water application rate of 250 l/ha using a nozzle at a pressure of 1.7 bar. A herbicide mixture of Mikado® (SC 300 g/l sulcotrione, 0.5 l/ha) and Motivell® (SC 40 g/l nicosulfuron, 0.5 l/ha) is applied without wetter or in combination with 100 and 200 ml/ha of Examples 7 and 9 according to the invention or the commercially available wetter BREAK-THRU® S 240 (BT S 240, Degussa Goldschmidt GmbH). The degree of weed control is determined 52 days after the treatment in the manner known to the expert worker by relating the weed biomass in the treated plots with the weed biomass in untreated plots in the manner known to the skilled worker, thus estimating the efficacy in percent. The efficacy of the weed control which is averaged over four replications is given in Table 3. The efficacy data with different letters a and b differ statistically significantly at P=0.05%; such values with identical letters do not differ statistically significantly at P=0.05%. The results demonstrate that compounds of the general formula II according to the invention significantly improve the efficacy of herbicides, even when the latter are applied at the very low dose of, for example, 100 ml/ha.

TABLE 3

| | | | Signifi- |
|---|---|---|---|
| | Treatment | Efficacy | cance |
| Comp. 10 | Mikado ® + Motivell ® | 78.8% | b |
| Ex. 20 | Mikado ® + Motivell ® + 100 ml/ha | 85.2% | a |
| | Example 7 | | |
| Ex. 21 | Mikado ® + Motivell ® + 200 ml/ha | 87.1% | a |
| | Example 7 | | |
| Ex. 22 | Mikado ® + Motivell ® + 100 ml/ha | 86.8% | a |
| | Example 9 | | |
| Ex. 23 | Mikado ® + Motivell ® + 200 ml/ha | 88.0% | a |
| | Example 9 | | |
| Comp. 11 | Mikado ® + Motivell ® + 100 ml/ha BT | 82.3% | ab |
| | S 240 | | |
| Comp. 12 | Mikado ® + Motivell ® + 200 ml/ha BT | 86.3% | a |
| | S 240 | | |

It can be concluded from the experiments that the compounds of the general formula II according to the invention improve the biological activity of fungicides and herbicides and thus act as bioactivators and activity enhancers. The consistency of the effects suggests that the compounds of the general formula II according to the invention enhance the efficacy of all biocides.

1. A cyclic siloxane of the general formula II 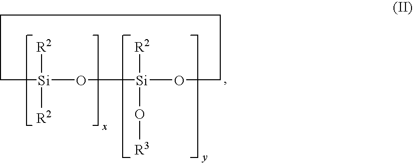
in which
R² are identical or different, straight-chain or branched, aliphatic or aromatic, optionally halogenated, optionally unsaturated hydrocarbon radicals having 1 to 8 carbon atoms,
x is 3, 4 or 5,
y is 1, 2 or 3,
R³ represents a group of the formula A-B-C-D, where
A is a group 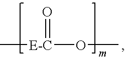
where
m is an integer from 0 to 30 and
E may be in each case independently a divalent group selected from among linear or branched, saturated, mono- or polyunsaturated alkyl, aryl, alkylaryl or arylalkyl groups having 1 to 20 carbon atoms,
B is a group of the general formula (III)
(C₂H₄O)ₙ(C₃H₆O)ₒ(C₁₂H₂₄O)ₚ(C₈H₈O)_{q}(C₄H₈O)ᵣ (III)
where
n, o, p, q and r independently of one another are integers from 0 to 50 and, if more than one of the indices n, o, p, q, r>0, the general formula III represents a random oligomer or a block oligomer,
C is selected from the group consisting of 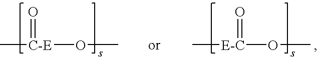
where
E in each case independently of one another can have the abovementioned meanings and
s is an integer from 0 to 20, but only other than 0 when the total of the indices n+o+p+q+r is 1 or greater,
and
D can be a radical selected from among hydrogen, linear or branched, saturated, mono- or polyunsaturated alkyl, aryl, alkylaryl or arylalkyl groups having 1 to 20 carbon atoms, optionally comprising one or more heteroatoms, optionally comprising one or more carbonyl groups, optionally modified with an ionic organic group which may comprise for example the heteroatoms of sulfur, phosphorus and/or nitrogen,
where the total of the indices m+n+o+p+q+r+s must be 3 or greater.

2. The cyclic siloxane as claimed in claim 1, wherein the total of the indices n+o must be 3 or greater, and R² represents a methyl group.

3. The cyclic siloxane as claimed in claim 1, wherein y has the value 1.

4. The cyclic siloxane as claimed in claim 1, wherein m=s=0.

5. The cyclic siloxane as claimed in claim 1 4, wherein the radical D is selected from the group consisting of 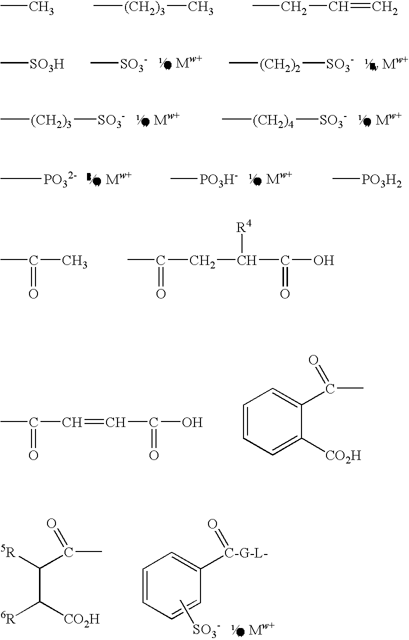
where
M^{w+} represents a w-valent cation with w=1, 2, 3 or 4, in particular K⁺, Na⁺, NH₄⁺, (i-C₃H₇)NH₃⁺ or (CH₃)₄N⁺, and
R⁴ represents hydrogen or an optionally branched aliphatic radical having 1 to 20 carbon atoms,
R⁵ and R⁶ represent identical or different, optionally bridged, optionally branched, aliphatic radicals,
G is an oxygen atom, NH or an NR⁷ group, where
R⁷ is a monovalent alkyl group, and
L represents a divalent, optionally branched, alkyl radical.

6. The cyclic siloxane as claimed in claim 1 4, wherein the radical D is selected from the group consisting of
—CH₃
—(CH₂)₃—CH₃
—CH₂—CH═CH₂
—SO₃⁻1/wM^{w+}
—(CH₂)₂—SO₃⁻1/wM^{w+}
—(CH₂)₃—SO₃⁻1/wM^{w+}
where
M^{w+} represents a w-valent cation with w=1, 2, 3 or 4.

7. The cyclic siloxane as claimed in claim 1 4, wherein the radical D is selected from the group consisting of allyl, n-butyl, ethyl and methyl.

8. A method of preparing stabilized polyesterpolyurethane foam which comprises of adding the cyclic siloxane of claim 1 during the process of making the polyesterpolyurethane foam.

9. A polyesterpolyurethane foam prepared by the method of claim 8.

10. The polyesterpolyurethane foam of claim 9 which further comprises one or more additives selected from the group consisting of flame retardants, cell opener, colors, UV-stabilizers and compounds preventing a microbial infection are used

11. A method for enhancing the activity of biocides which comprises of adding a cyclic siloxane of claim 1 to the biocides.

12. The cyclic siloxane of claim 6, wherein M^{w+} represents a w-valent cation with w=1, 2, 3 or 4, K⁺, Na⁺, NH₄⁺, (i-C₃H₇)NH₃⁺ or (CH₃)₄N⁺.

13. The cyclic siloxane as claimed in claim 5, wherein the total of the indices n+o must be 3 or greater, y has the value 1, m=s=0, and R² represents a methyl group.

14. The cyclic siloxane as claimed in claim 6, wherein the total of the indices n+o must be 3 or greater, y has the value 1, m=s=0, and R² represents a methyl group.

15. The cyclic siloxane as claimed in claim 7, wherein the total of the indices n+o must be 3 or greater, y has the value 1, m=s=0, and R² represents a methyl group.
